(19) United States
(12) Patent Application Publication
(10) Pub. No.: US 2023/0126075 A1
(43) Pub. Date: Apr. 27, 2023

(54) Clamping Force Visualization Clamp and Clamping Force Visualization Clamp Combination Device

(71) Applicant: HANGZHOU GREAT STAR INDUSTRIAL CO., LTD., Hangzhou City (CN)

(72) Inventor: Yueming LI, Hangzhou (CN)

(21) Appl. No.: 18/086,701

(22) Filed: Dec. 22, 2022

Related U.S. Application Data
(63) Continuation-in-part of application No. 17/295,460, filed on May 20, 2021, now Pat. No. 11,559,874.

(30) Foreign Application Priority Data
Jan. 11, 2019 (CN) 201910026507.7

(51) Int. Cl. B25B 5/06; B25B 5/02; B25B 5/16

(52) U.S. Cl. CPC B25B 5/068; B25B 5/02; B25B 5/16

(57) ABSTRACT

A clamping force visualization clamp and a clamping force visualization clamp combination device. The clamping force visualization clamp includes a clamping force visualization device, the clamping force visualization device includes a first clamping body (01) for clamping an object, the first clamping body (01) is telescopically assembled on a base (14), an elastic element (110) is provided between the first clamping body (01) and the base (14), a clamping force scale (11) and a reading indicator (15) are respectively provided on the first clamping body (01) and the base (14), when the first clamping body (01) clamps the object, the elastic element (110) measures a clamping force, and the reading indicator (15) points to the clamping force scale (11) for reading, so that the magnitude of the clamping force can be intuitively seen and read during clamping, thereby achieving accurate clamping. A clamp including the clamping force visualization device is also involved.

### CROSS-REFERENCE TO RELATED APPLICATION(S

The present application claims benefit of U.S. Application No. 17/295,460, filed to the U.S. Patent Office, on May 20, 2021, entitled “Clamping Force Visualization Device and Clamp”, the disclosure of which is hereby incorporated by reference in its entirety.

### TECHNICAL FIELD

The present disclosure belongs to a field of manual clamps, and in particular, relates to a manually-operated clamping force visualization clamp and a clamping force visualization clamp combination device.

### BACKGROUND

In addition to the basic function of clamping, for the existing manual clamps, during use, the magnitude of a clamping force is often difficult to be determined, which results in the blindness of clamping and makes it difficult to accurately achieve the purpose of clamping.

### SUMMARY

The technical problem to be solved and the technical task proposed in the present disclosure are to overcome the defect that it is difficult to determine the magnitude of a clamping force during the use of an existing manual clamp, and to provide a clamping force visualization clamp and a clamping force visualization clamp combination device, such that the magnitude of the clamping force is intuitively seen and read during clamping, thereby realizing accurate clamping.

In order to achieve the above objective, a clamping force visualization device of the present disclosure includes a first clamping body for clamping an object, wherein the first clamping body is telescopically assembled on a base, an elastic element is provided between the first clamping body and the base, a clamping force scale and a reading indicator are respectively provided on the first clamping body and the base, and when the first clamping body clamps the object, the elastic element measures a clamping force, and the reading indicator points to the clamping force scale for reading.

As a preferred technical means of the clamping force visualization device, the base and the first clamping body are sleeved together, the base or the first clamping body located at an outer side is provided with the reading indicator or the clamping force scale, and the first clamping body or the base located at an inner side is provided with the visible clamping force scale or the reading indicator.

As a preferred technical means of the clamping force visualization device, the base is provided with an axial hole, the first clamping body is provided with a telescopic section, and the axial hole is sleeved on the telescopic section.

As a preferred technical means of the clamping force visualization device, the telescopic section is provided with an inner hole, and one end of the elastic element is supported at the bottom of the axial hole, and the other end of the elastic element is supported at the bottom of the inner hole.

As a preferred technical means of the clamping force visualization device, the base or the first clamping body is provided with a column, and the elastic element is a helical compression spring sleeved on the column.

As a preferred technical means of the clamping force visualization device, a window is provided on the base or the first clamping body at the outer side, and the reading indicator or the clamping force scale is provided at an edge of the window.

As a preferred technical means of the clamping force visualization device, a front end edge of the base or the first clamping body located at the outer side is used as the reading indicator, and the clamping force scale is provided on the first clamping body or the base located at the inner side.

As a preferred technical means of the clamping force visualization device, an adjustment screw is configured for the first clamping body, the adjustment screw passes through the first clamping body and is connected to the base, and the adjustment screw is screwed to adjust an initial pressure of the first clamping body on the elastic element.

In order to achieve the above objective, a clamping force visualization clamp of the present disclosure includes the clamping force visualization device of the present disclosure, and a second clamping body cooperating with the first clamping body to realize clamping, the base is provided on a first arm, the second clamping body is provided on a second arm, and both the first arm and the second arm are rigid structures.

As a preferred technical means of the clamping force visualization clamp, a fixed handle integrally extends from the first arm, the second arm is fixed on a guide rod, the guide rod is provided on the first arm in a penetrating manner, the first arm is provided with a force-applying handle, an unlocking handle, a force-applying clamping piece for applying a force to the guide rod, and a locking clamping piece for locking the guide rod on the first arm, the force-applying handle is linked with the force-applying clamping piece, such that when the force-applying handle and the fixed handle are gripped, the guide rod is caused to slide, and the second arm moves close to the first arm, and the unlocking handle is linked with the locking clamping piece, such that when the unlocking handle and the fixed handle are gripped, the locking of the locking clamping piece on the guide rod is released.

As a preferred technical means of the clamping force visualization clamp, the base is provided on a first arm, the second clamping body is provided on a second arm, the first arm is connected with a clamping handle and an unlocking handle, the second arm is fixed on a guide rod, and the guide rod is provided on the first arm in a penetrating manner.

As a preferred technical means of the clamping force visualization clamp, the base is provided on a first arm, the second clamping body is provided on a second arm, a first handle extends from the first arm, a second handle extends from the second arm, the first arm and the second arm are connected by a pivot, and a locking mechanism and an unlocking mechanism are provided between the first handle and the second handle.

As a preferred technical means of the clamping force visualization clamp, the base and the first arm are made integrally together.

As a preferred technical means of the clamping force visualization clamp, the base is assembled on the first arm.

As a preferred technical means of the clamping force visualization clamp, the base is mounted on the first arm in a snap-fit manner.

As a preferred technical means of the clamping force visualization clamp, the base is assembled on the first arm by a pin bolt.

In the present disclosure, a clamping body is telescopically assembled on a base, an elastic element is provided between the clamping body and the base, and a clamping force scale and a reading indicator are respectively provided on the clamping body and the base; and when an object is clamped, the elastic element measures a clamping force, and the reading indicator points to the clamping force scale for reading, so that the magnitude of the clamping force can be intuitively seen and read during clamping, thereby realizing accurate clamping.

### BRIEF DESCRIPTION OF THE DRAWINGS

FIG. 1 is a schematic diagram of a first type of clamping force visualization clamp in the present disclosure;

FIG. 2 is a top view of FIG. 1;

FIG. 3 is an A-A sectional view of FIG. 2;

FIG. 4 is a schematic diagram showing an external structure in which a first clamping body is telescopically assembled on a base in the present disclosure;

FIG. 5 is a schematic diagram showing an internal structure in which the first clamping body is telescopically assembled on the base in the present disclosure;

FIG. 6 is a schematic diagram of a second type of clamping force visualization clamp in the present disclosure;

FIG. 7 is a schematic diagram of a third type of clamping force visualization clamp in the present disclosure;

FIG. 8 is a schematic diagram in which a base and a first arm are made integrally together, and a front end edge of the base is used as a reading indicator in the present disclosure;

FIG. 9 is a schematic diagram in which the base is assembled on the first arm by a lateral pin bolt in the present disclosure;

FIG. 10 is a schematic diagram in which the base is assembled on the first arm by a transverse pin bolt in the present disclosure;

FIG. 11 is a schematic diagram of a fourth type of clamping force visualization clamp in the present disclosure;

FIG. 12 is a sectional view of the clamping force visualization clamp in FIG. 11;

FIG. 13 is a schematic diagram of a first arm of the clamping force visualization clamp in FIG. 11;

FIG. 14 is a schematic diagram of a second arm of the clamping force visualization clamp in FIG. 11;

FIG. 15 is a schematic diagram of a first type of clamping force visualization clamp combination device in the present disclosure;

FIG. 16 is a schematic diagram of a cooperating piece of the clamping force visualization clamp combination device in FIG. 15;

FIG. 17 is a schematic diagram of another use state of the clamping force visualization clamp combination device in FIG. 15;

FIG. 18 is a schematic diagram of a second type of clamping force visualization clamp combination device in the present disclosure;

FIG. 19 is a schematic diagram of a first use state of a third type of clamping force visualization clamp combination device in the present disclosure;

FIG. 20 is a schematic diagram of a clamping groove of the clamping force visualization clamp combination device in FIG. 19;

FIG. 21 is a schematic diagram of a second use state of the clamping force visualization clamp combination device in FIG. 19;

FIG. 22 is a schematic diagram of a third use state of the clamping force visualization clamp combination device in FIG. 19; and

FIG. 23 is a schematic diagram of a fourth use state of the clamping force visualization clamp combination device in FIG. 19.

### DESCRIPTION OF REFERENCE SIGNS IN THE DRAWINGS

01:first clamping body, 11:clamping force scale, 12:telescopic section, 13:inner hole, 14:base, 15:reading indicator, 16:window, 17:axial hole, 18:column, 19:clamping groove, 110:elastic element, 111adjustment screw, 112:pad;
02:second clamping body;
03:first arm, 31:fixed handle, 32:force:applying handle, 33:unlocking handle, 34:force:applying clamping piece, 35:locking clamping piece, 36:clamping handle, 37:unlocking handle, 38:first handle; 39:plastic base;
04:second arm, 41:second handle;
05:guide rod;
06:pivot;
07:locking mechanism;
08:unlocking mechanism;
09:pin bolt;
120:cooperating piece; 130 connecting piece; 140 clamping groove.

### DETAILED DESCRIPTION OF THE EMBODIMENTS

The present disclosure is further described below in combination with the drawings.

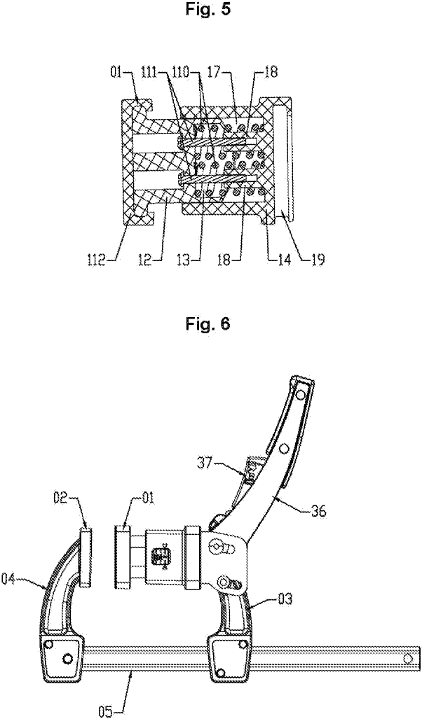

A clamping force visualization device as shown in FIG. 4 and FIG. 5 includes a first clamping body 01 for clamping an object, the first clamping body 01 is telescopically assembled on a base 14, an elastic element 110 is provided between the first clamping body 01 and the base 14, a clamping force scale 11 is provided on the first clamping body 01, a reading indicator 15 is provided on the base 14, when the first clamping body 01 clamps the object, the elastic element 110 measures a clamping force, and the reading indicator 15 points to the clamping force scale 11 for reading, such that the magnitude of the clamping force can be intuitively seen and read, thereby achieving accurate clamping. During clamping, as the magnitude of the clamping force changes, the relative position between the reading indicator and the clamping force scale will change, therefore, during specific implementation, the positions of the reading indicator and the clamping force scale can be exchanged.

In order to achieve a compact structure and accurate measurement, the base 14 and the first clamping body 01 are sleeved together, as shown in FIG. 4 and FIG. 5, a window 16 is provided on the base 14 located at an outer side, the reading indicator 15 is provided at an edge of the window and the clamping force scale 11 visible through the window is provided on the first clamping body 01 located at an inner side. During specific implementation, the window may be provided on the first clamping body located on the outer side, the reading indicator is provided at the edge of the window, and the clamping force scale visible through the window is provided on the base located at an inner side. Further, the positions of the reading indicator and the clamping force scale may be exchanged regardless of which one of the base and the first clamping body is at the outer side.

In addition, as shown in FIG. 8, a front end edge of the base 14 located at the outer side is used as the reading indicator, and the clamping force scale is provided on the first clamping body located at the inner side. Obviously, the front end edge of the first clamping body located at the outer side may also be used as the reading indicator, and the clamping force scale is provided on the base located at the inner side.

In order to avoid the inaccuracy of measurement of the clamping force caused by the shaking of the clamping body, the base 14 is provided with an axial hole 17, the first clamping body 01 is provided with a telescopic section 12, and the axial hole 17 is sleeved on the telescopic section 12. Further, the telescopic section 12 is provided with an inner hole 13, one end of the elastic element 110 is supported at the bottom of the axial hole 17, and the other end of the elastic element 110 is supported at the bottom of the inner hole 13. The base is provided with a column 18, and the elastic element 110 is a helical compression spring sleeved on the column 18, so that the helical compression spring is supported by the column while ensuring a compact structure, thereby avoiding inaccuracy of measurement caused by the bending of the helical compression spring when the helical compression spring is pressed. In view of the supporting function of the column for the helical compression spring, the column may also be provided on the first clamping body.

In order to calibrate and adjust the initial pressure of the elastic element, an adjustment screw 111 is configured for the first clamping body, and the adjustment screw 111 passes through the first clamping body and is connected to the base 14 for maintaining the assembly relationship of the first clamping body, the base and the elastic element, and moreover, the initial pressure of the first clamping body on the elastic element may be adjusted by screwing the adjustment screw. Depending on use requirements, the initial pressure may be zero, or a certain pressure value. In view of this, the clamping force scale and the reading indicator may be marked (such as imprinting, laser marking and pad printing) at corresponding positions after calibration and adjustment. As shown in the figures, the first clamping body includes a pad 112 at an end port thereof, and the pad shields the adjustment screw. Likewise, a second clamping body includes a pad at an end portion thereof, and the pad may increase the contact with the clamped object while protecting the surface of the clamped object.

On the basis of the above clamping force visualization device, a clamp includes the clamping force visualization device and a second clamping body 02 cooperating with the first clamping body 01 to realize clamping, i.e. being able to be used for clamping an object, and the clamp may take various forms.

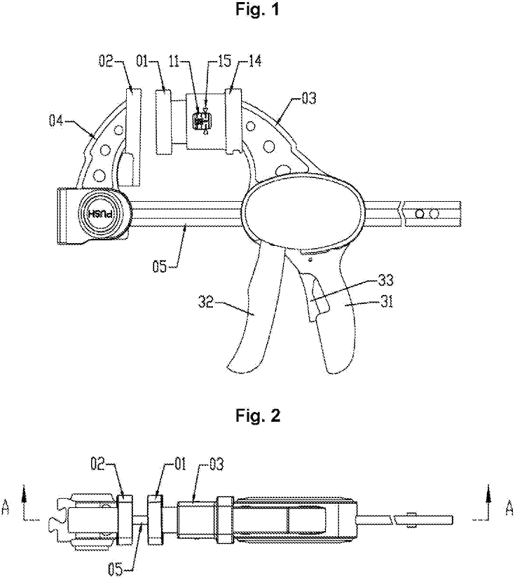

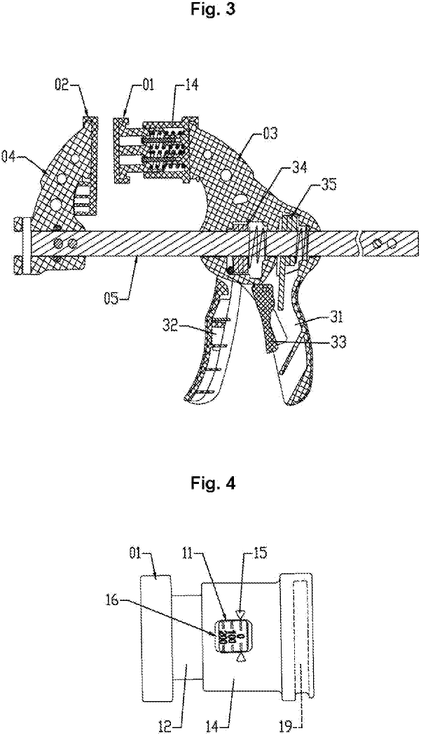

The structure form of one type of clamp is as shown in FIGS. 1-3, which is an F clamp, the first clamping body 01 is provided on a first arm 03, the second clamping body 02 is provided on a second arm 04, a fixed handle 31 integrally extends from the first arm 03, the second arm 04 is fixed on a guide rod 05, and the guide rod 05 is provided on the first arm 03 in a penetrating manner, the first arm 03 is provided with a force-applying handle 32, an unlocking handle 33, a force-applying clamping piece 34 for applying a force to the guide rod, and a locking clamping piece 35 for locking the guide rod on the first arm, the force-applying handle 32 is linked with the force-applying clamping piece 34, such that when the force-applying handle and the fixed handle are gripped, the guide rod 05 is caused to slide, and the second arm 04 moves close to the first arm 03, and the unlocking handle 33 is linked with the locking clamping piece 35, such that when the unlocking handle and the fixed handle are gripped, the locking of the locking clamping piece on the guide rod is released, so as to release the clamping.

The structure form of another type of clamp is as shown in FIG. 6, the first clamping body 01 is provided on the first arm 03, the second clamping body 02 is provided on the second arm 04, the first arm 03 is connected with the clamping handle 36 and the unlocking handle 37, the second arm 04 is fixed on the guide rod 05, and the guide rod 05 is provided on the first arm 03 in a penetrating manner, clamping may be achieved by operating the clamping handle 36, and unlocking of the clamping may be achieved by operating the unlocking handle 37, so as to release the clamping.

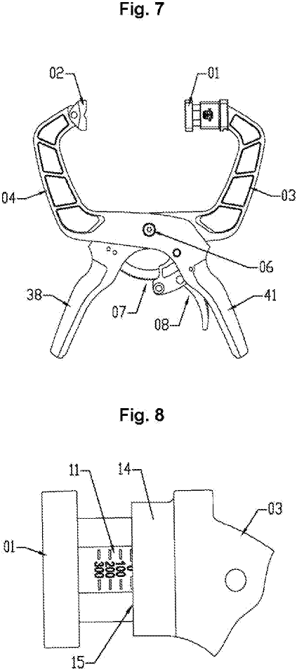

The structure form of a third type of clamp is as shown in FIG. 7, the first clamping body 01 is provided on the first arm 03, the second clamping body 02 is provided on the second arm 04, the first handle 38 extends from the first arm 03, the second handle 41 extends from the second arm 04, the first arm 03 and the second arm 04 are connected by a pivot 06, a locking mechanism 07 and an unlocking mechanism 08 are provided between the first handle 38 and the second handle 41, the locking mechanism is a ratchet-pawl mechanism, and the unlocking mechanism includes a handle. By gripping the first handle 38 and the second handle 41, clamping is achieved and is locked by the locking mechanism, and unlocking is achieved by operating the unlocking mechanism, so as to release the clamping.

Regardless which structure form the clamp is taken, both the base 14 and the first arm 03 may be made integrally together as shown in FIG. 8. Or, the base 14 is assembled on the first arm 03, such that the base, the first clamping body and the elastic elements form an integral structure as shown in FIG. 4 and FIG. 5, which is independent of other structures of the clamp, the independent structure has a relatively small volume, thereby facilitating circulation between stations when calibrating and adjusting the initial pressure of the elastic element.

The base 14 shown in FIGS. 1-3, 6 and 7 is mounted on the first arm 03 in a snap-fit manner, specifically, the base 14 is provided with a clamping groove 19 as a connecting structure, one side (the lower side as shown in the figures) of the clamping groove is open, and the remaining sides are enclosed, and the base may be conveniently snap-fitted at the mounting position of the base by the opening. Correspondingly, the end portion of the first arm which fits the clamping groove is provided with a head fitting with the clamping groove, and a snap-fitting with a certain pre-tightening force is realized by using the elasticity of a material (such as engineering plastics), so as to avoid separation. Such an assembly manner particularly facilities the assembly.

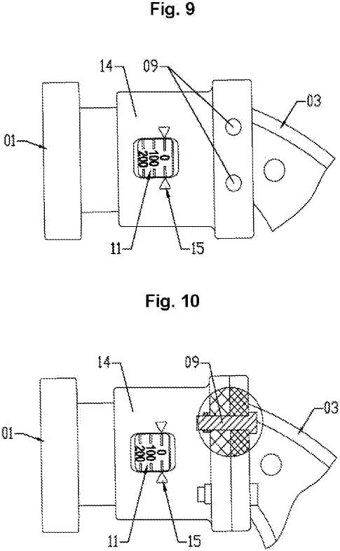

The base 14 shown in FIG. 9 is assembled at the end portion of the first arm 03 by a lateral (a direction perpendicular to the paper surface as shown in the figure) pin bolt, at this time, the base is preferably sleeved with the first arm, and the pin bolt is provided at the overlapping section of the base and the first arm in a penetrating manner.

The base 14 shown in FIG. 10 is assembled at the end portion of the first arm 03 by a transverse (left-right direction as shown in the figure) pin bolt, and at this time, a flange for the pin bolt to penetrate through may be provided on the base and the first arm.

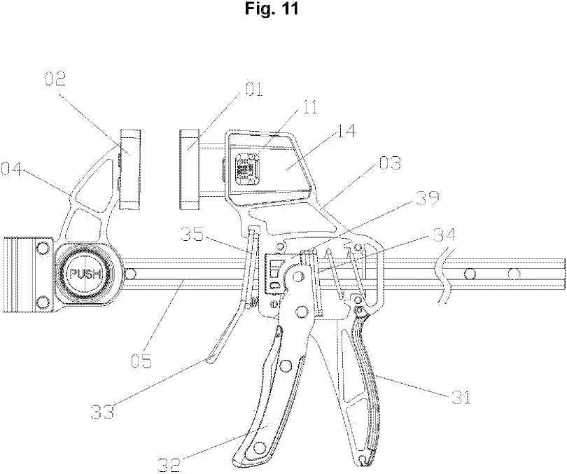

The structural form of a fourth type of clamp is as shown in FIGS. 11-14, and the structure of the fourth type of clamp differs from the above embodiment in the material of the first arm 03 and the second arm 04. In the structure of the fourth type of clamp, both the first arm 03 and the second arm 04 are rigid structures. The above structure has relatively good strength and is easy to process.

Preferably, the first arm 03 and the second arm 04 are made of a metal material. Further preferably, the metal material is an alloy. Specifically, the alloy is an aluminum alloy.

Both the first arm 03 and the second arm 04 are section parts. A plurality of section parts may be processed at one time by means of cutting batch production. The aluminum alloy may also achieve a multi-color surface by oxidation.

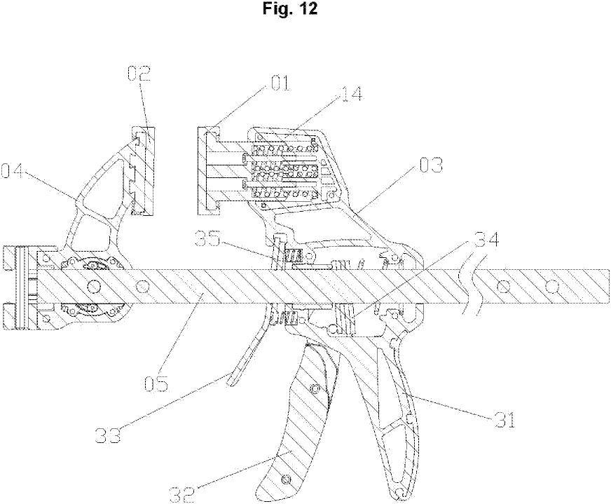

As shown in FIG. 11 and FIG. 12, the unlocking handle 33, the force-applying clamping piece 34, and the locking clamping piece 35 of the fourth type of fixture are different from those in the above embodiments. Specifically, the unlocking handle 33 is located on the side of the first arm 03 facing the second arm 04, the locking clamping piece 35 is located between the unlocking handle 33 and the first arm 03, and the unlocking handle 33 and the locking clamping piece 35 may be of an integrated structure or may be separately provided iron sheets. The force-applying handle 32 is linked with the force-applying clamping piece 34, such that when the force-applying handle 32 and the fixed handle 31 are gripped, the guide rod 05 is caused to slide, and the second arm 04 moves close to the first arm 03, and the unlocking handle 33 is linked with the locking clamping piece 35, such that when the unlocking handle 35 and the fixed handle 31 are gripped, the locking of the locking clamping piece 35 on the guide rod is released, so as to release the clamping.

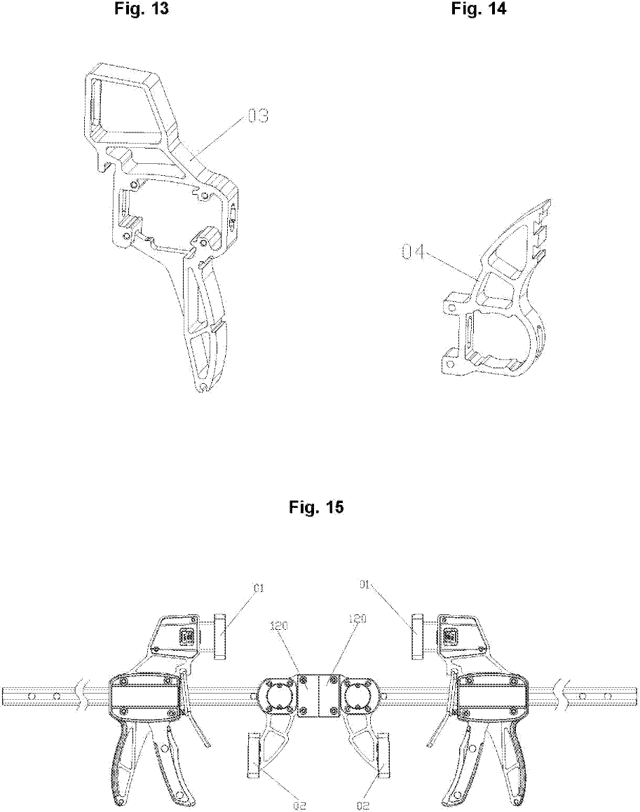

With reference to FIGS. 11-14, the assembly manner of the fourth type of clamp also differs from the above embodiments, especially the assembly among the first arm 03, the base 14 and the force-applying handle 32. As shown in FIG. 13, the top of the first arm 03 is provided with a first mounting frame, the base 14 is accommodated in the first mounting frame, a side wall of the first mounting frame is provided with an avoidance opening, and a part of the first clamping body 01 extends into the base 14 after passing through the avoidance opening. The middle of the first arm 03 is provided with a second mounting frame, a plastic seat 39 is accommodated in the second mounting frame, and the force-applying handle 32 is connected with the plastic seat 39. Both the second mounting frame and the plastic base 39 are provided with through holes for the guide rod 05 to pass through.

In the drawings, although the first clamping body and the second clamping body are determined by reference signs, but practical implementation is not limited to such representation forms, and the positions of the first clamping body and the second clamping body may be exchanged, and the concept of the present disclosure can also be embodied.

The present application further provides a clamping force visualization clamp combination device.

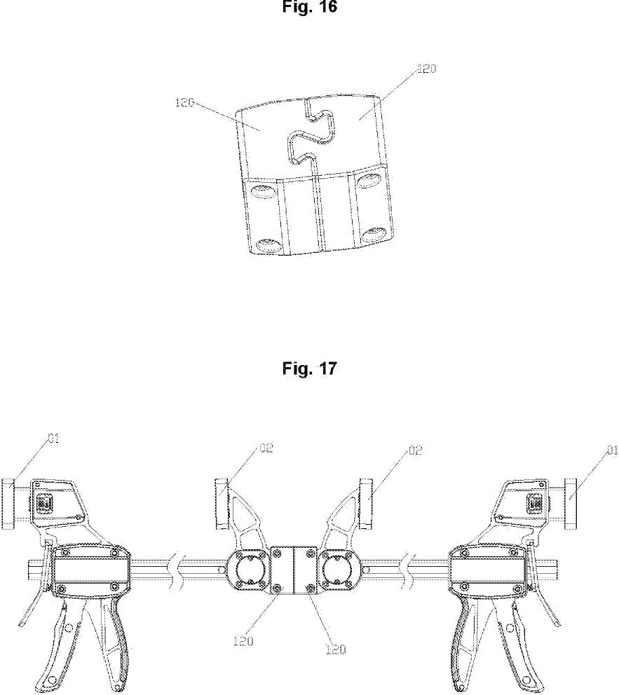

The structural form of a first type of clamping force visualization clamp combination device is shown in FIGS. 15-17. The first type of clamping force visualization clamp combination device includes a first clamping force visualization clamp and a second clamping force visualization clamp, which are in butt joint fit with each other, both the first clamping force visualization clamp and the second clamping force visualization clamp are the clamping force visualization clamps mentioned above, and the first clamping body 01 of the first clamping force visualization clamp and the first clamping body 01 of the second clamping force visualization clamp are oppositely arranged (as shown in FIG. 15) or are arranged back to back (as shown in FIG. 17).

As shown in FIG. 16, the second clamping body 02 of the first clamping force visualization clamp and the second clamping body 02 of the second clamping force visualization clamp are both provided with cooperating pieces 120, and the first clamping force visualization clamp and the second clamping force visualization clamp are connected together by the cooperating pieces 120. As shown in FIG. 16, the cooperating piece 120 on the second clamping body 02 of the first clamping force visualization clamp is of a left-side structure, the cooperating piece 120 on the second clamping body 02 of the second clamping force visualization clamp is of a right-side structure, and the two cooperating pieces 120 (the left-side structure and the right-side structure) are engaged with each other, so as to realize interconnection and realize the disconnection and connection of the clamping bodies.

The structural form of a second type of clamping force visualization clamp combination device is shown in FIG. 18. As shown in FIG. 18, the clamping force visualization clamp combination device further includes a connecting piece 130, and the first clamping force visualization clamp and the second clamping force visualization clamp are connected together by the connecting piece 130. The connecting piece 130 may be cooperate and fixed with the guide rod by a pin bolt, and is fastened by a fastening bolt, when the two clamps need to be split, the fastening bolt is loosened, and the connecting piece does not match the pin bolt on the guide rod, so that the two clamps are separated.

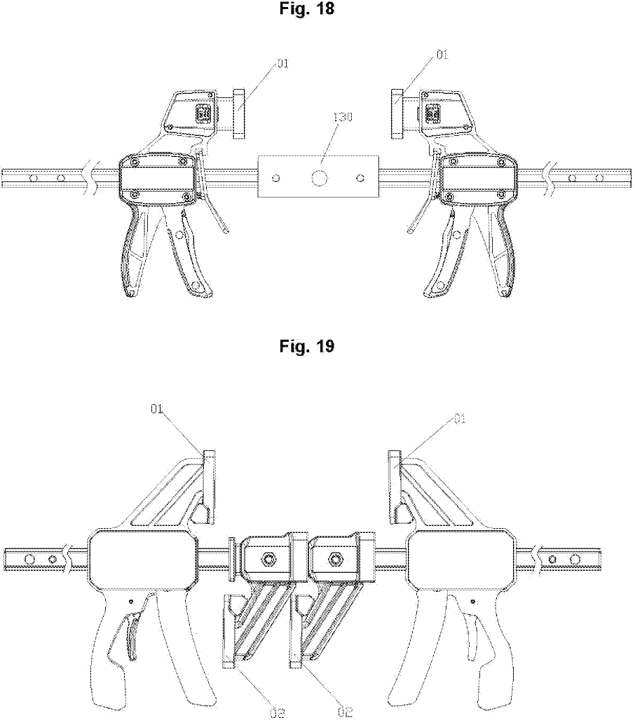

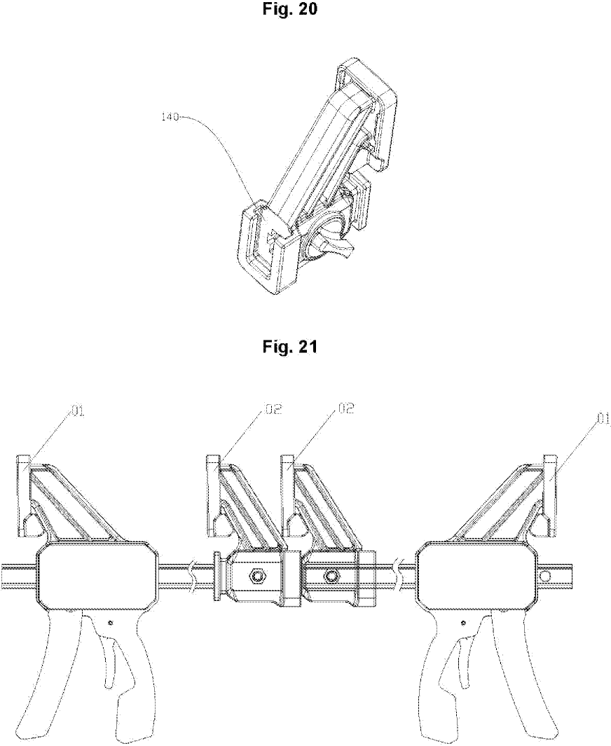

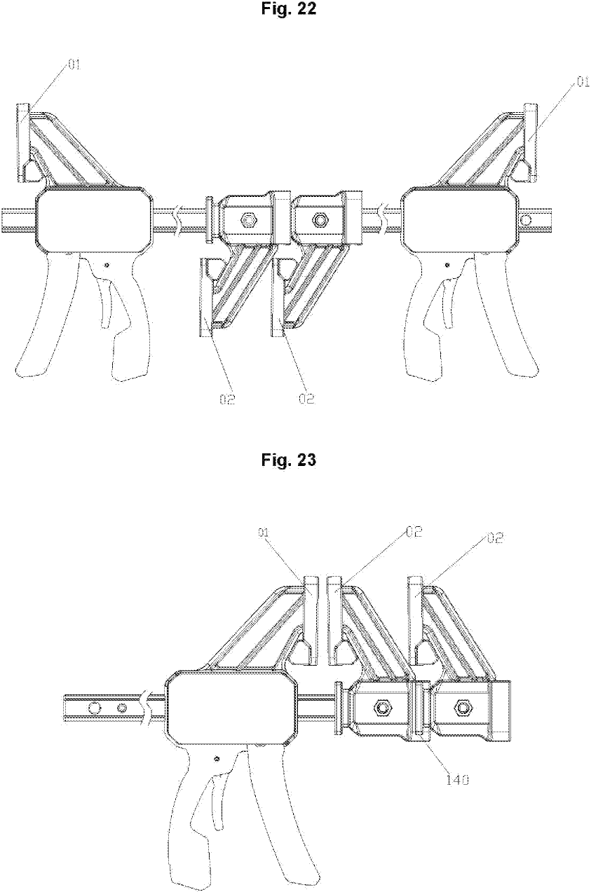

The structural form of a third type of clamping force visualization clamp combination device is shown in FIGS. 19-23. In the third type of clamping force visualization clamp combination device, the second clamping body 02 of the first clamping force visualization clamp and the second clamping body 02 of the second clamping force visualization clamp are both provided with cooperating pieces, and the first clamping force visualization clamp and the second clamping force visualization clamp are connected together by the cooperating pieces. As shown in FIG. 20, one cooperating piece is provided with a clamping groove 140, and the other cooperating piece is inserted into the clamping groove 140 to implement connection.

Of course, as a feasible use mode, as shown in FIG. 23, the first clamping body 01 and the second clamping body 02 of the first clamping force visualization clamp may be assembled together only with the second clamping body 02 of the second clamping force visualization clamp.

1. A clamping force visualization clamp, comprising: a clamping force visualization device, and the clamping force visualization device comprises:
a first clamping body (01) for clamping an object, wherein the first clamping body (01) is telescopically assembled on a base (14), an elastic element (110) is provided between the first clamping body (01) and the base (14), a clamping force scale (11) and a reading indicator (15) are respectively provided on the first clamping body (01) and the base (14), when the first clamping body (01) clamps the object, the elastic element (110) measures a clamping force, and the reading indicator (15) points to the clamping force scale (11) for reading;
an adjustment structure is configured for the first clamping body, and the adjustment structure is used for adjusting an initial pressure of the first clamping body on the elastic element;
the clamping force visualization clamp further comprises a second clamping body (02) matching the first clamping body (01) for realizing clamping; and
the base (14) is provided on a first arm (03), the second clamping body (02) is provided on a second arm (04), wherein both the first arm (03) and the second arm (04) are rigid structures.

2. The clamping force visualization clamp according to claim 1, wherein the first arm (03) and the second arm (04) are made of a metal material.

3. The clamping force visualization clamp according to claim 2, wherein the metal material is an alloy.

4. The clamping force visualization clamp according to claim 3, wherein the metal material is an aluminum alloy.

5. The clamping force visualization clamp according to claim 1, wherein both the first arm (03) and the second arm (04) are section parts.

6. The clamping force visualization clamp according to claim 1, wherein a fixed handle (31) integrally extends from the first arm (03), the second arm (04) is fixed on a guide rod (05), the guide rod (05) is provided on the first arm (03) in a penetrating manner, the first arm (03) is provided with a force-applying handle (32), an unlocking handle (33), a force-applying clamping piece (34) for applying a force to the guide rod, and a locking clamping piece (35) for locking the guide rod on the first arm, the force-applying handle (32) is linked with the force-applying clamping piece (34), such that when the force-applying handle (32) and the fixed handle (31) are gripped, the guide rod (05) is caused to slide, and the second arm (04) moves close to the first arm (03), and the unlocking handle (33) is linked with the locking clamping piece (35), such that when the unlocking handle (33) and the fixed handle (31) are gripped, a locking of the locking clamping piece (35) on the guide rod is released.

7. The clamping force visualization clamp according to claim 1, wherein the base (14) is provided on a first arm (03), the second clamping body (02) is provided on a second arm (04), the first arm (03) is connected with a clamping handle (36) and an unlocking handle (37), the second arm (04) is fixed on a guide rod (05), and the guide rod (05) is provided on the first arm (03) in a penetrating manner.

8. The clamping force visualization clamp according to claim 1, wherein the base (14) is provided on a first arm (03), the second clamping body (02) is provided on a second arm (04), a first handle (38) extends from the first arm (03), a second handle (41) extends from the second arm (04), the first arm and the second arm are connected by a pivot (06), and a locking mechanism (07) and an unlocking mechanism (08) are provided between the first handle and the second handle.

9. The clamping force visualization clamp according to claim 6, wherein the base (14) and the first arm (03) are made integrally together.

10. The clamping force visualization clamp according to claim 6, wherein the base (14) is assembled on the first arm (03); the base (14) is mounted on the first arm (03) in a snap-fit manner; or, the base (14) is assembled on the first arm (03) by a pin bolt.

11. The clamping force visualization clamp according to claim 1, wherein the base (14) and the first clamping body (01) are sleeved together, the base (14) or the first clamping body located at an outer side is provided with the reading indicator or the clamping force scale, and the first clamping body or the base located at an inner side is provided with the visible clamping force scale or the reading indicator.

12. The clamping force visualization clamp according to claim 11, wherein the base (14) is provided with an axial hole (17), the first clamping body (01) is provided with a telescopic section (12), and the axial hole (17) is sleeved on the telescopic section (12).

13. The clamping force visualization clamp according to claim 12, wherein the telescopic section (12) is provided with an inner hole (13), and one end of the elastic element (110) is supported at a bottom of the axial hole (17), and the other end of the elastic element (110) is supported at a bottom of the inner hole (13).

14. The clamping force visualization clamp according to claim 13, wherein the base (14) or the first clamping body is provided with a column (18), and the elastic element (110) is a helical compression spring sleeved on the column (18).

15. The clamping force visualization clamp according to claim 11, wherein a window (16) is provided on the base (14) or the first clamping body located at the outer side, and the reading indicator or the clamping force scale is provided at an edge of the window.

16. The clamping force visualization clamp according to claim 2, wherein a front end edge of the base (14) or the first clamping body located at the outer side is used as the reading indicator, and the clamping force scale is provided on the first clamping body or the base located at the inner side.

17. The clamping force visualization clamp according to claim 1, wherein the adjustment structure is an adjustment screw (111), the adjustment screw (111) passes through the first clamping body (01) and is connected to the base (14), and the adjustment screw is screwed to adjust the initial pressure of the first clamping body on the elastic element.

18. A clamping force visualization clamp combination device, comprising a first clamping force visualization clamp and a second clamping force visualization clamp, which are in but joint fit with each other, wherein a first clamping body (01) of the first clamping force visualization clamp and a first clamping body (01) of the second clamping force visualization clamp are arranged opposite to each other or back to back; and each of the first clamping force visualization clamp and the second clamping force visualization clamp comprises:
a first clamping body (01) for clamping an object, wherein the first clamping body (01) is telescopically assembled on a base (14), an elastic element (110) is provided between the first clamping body (01) and the base (14), a clamping force scale (11) and a reading indicator (15) are respectively provided on the first clamping body (01) and the base (14), when the first clamping body (01) clamps the object, the elastic element (110) measures a clamping force, and the reading indicator (15) points to the clamping force scale (11) for reading; and
an adjustment structure is configured for the first clamping body, and the adjustment structure is used for adjusting an initial pressure of the first clamping body on the elastic element.

19. The clamping force visualization clamp combination device according to claim 18, wherein each of the first clamping force visualization clamp and the second clamping force visualization clamp further comprises:
a second clamping body (02) matching the first clamping body (01) for realizing clamping; and
the base (14) is provided on a first arm (03), the second clamping body (02) is provided on a second arm (04), wherein both the first arm (03) and the second arm (04) are rigid structures.

20. The clamping force visualization clamp combination device according to claim 19, wherein both the second clamping body (02) of the first clamping force visualization clamp and the second clamping body (02) of the second clamping force visualization clamp are provided with cooperating pieces (120), and the first clamping force visualization clamp and the second clamping force visualization clamp are connected together by the cooperating pieces (120); or, the clamping force visualization clamp combination device further comprises a connecting piece (130), and the first clamping force visualization clamp and the second clamping force visualization clamp are connected together by the connecting piece (130).
